(19) United States
(12) Patent Application Publication
(10) Pub. No.: US 2025/0304415 A1
(43) Pub. Date: Oct. 2, 2025

(54) HAND TRUCK FOR MOVING CERAMIC COOKERS

(71) Applicant: Stanley FLOWERS, Temple, GA (US)

(72) Inventor: Stanley FLOWERS, Temple, GA (US)

(21) Appl. No.: 19/090,617

(22) Filed: Mar. 26, 2025

Related U.S. Application Data
(60) Provisional application No. 63/572,589, filed on Apr. 1, 2024.

(51) Int. Cl. B66F 9/18; B66F 17/00

(52) U.S. Cl. CPC B66F 9/18; B66F 17/00

(57) ABSTRACT

A hand truck for lifting, moving, and lowering ceramic cookers. The device minimizes the risk of injury to the worker or person moving the ceramic cooker and minimizes the risk of damage to the ceramic cooker during lifting, moving, and lowering. The hand truck includes a generally upright frame, a first pair of wheels attached to the frame for movably supporting the frame upon a surface, and a movable carriage mounted to the frame for up and down movement. A lifting mechanism is mounted to the frame for raising and lowering the movable carriage. A yoke mounted to the movable carriage is adapted to be positioned at least partially around the ceramic cooker and to support the ceramic cooker during lifting, lowering, and relocation.

### BACKGROUND

Ceramic cookers, such as ceramic smokers and ceramic grills, are rather heavy and generally lack suitable handles for lifting and lowering. Indeed, moving ceramic cookers is well known for causing injuries and damage to the cookers. At present, there are no known practical mechanisms for moving or relocating ceramic cookers.

### SUMMARY OF THE INVENTION

Briefly described, the present invention provides a new and useful device for lifting, moving, and lowering ceramic cookers. The device minimizes the risk of injury to the worker or person moving the ceramic cooker and minimizes the risk of damage to the ceramic cooker during lifting, moving, and lowering.

Example embodiments of the present disclosure can include a hand truck for moving a ceramic cooker, including a generally upright frame. Such can also include a first pair of wheels attached to the frame for movably supporting the frame upon a surface, as well as a movable carriage mounted to the frame for up and down movement.

A lifting mechanism can be mounted to the frame for raising and lowering the movable carriage. A yoke can be mounted to the movable carriage and adapted to be positioned at least partially around the ceramic cooker and to support the ceramic cooker. In some embodiments, the hand truck can be moved into position to place the yoke at least partially around the ceramic cooker and the lifting mechanism operated to raise the ceramic cooker and to support the ceramic cooker while the hand truck can be wheeled from one place to another, whereupon the lifting mechanism can be operated to lower the ceramic cooker into position at a new location.

Embodiments can also include a second pair of wheels positioned to create, in conjunction with the first pair of wheels, a four wheel lower frame positioned to stably support the hand truck while loaded with a ceramic cooker.

Optionally, the lifting mechanism can include a winch. In some embodiments, the winch can be hand-powered. In other embodiments, the winch can include an electric winch.

In some embodiments, the movable carriage can include a receiver and the yoke can be removably mounted in the receiver. Optionally, the hand truck can also include a plurality of yokes of various sizes to accommodate and support ceramic cookers of various sizes.

In some embodiments, the generally upright frame can include two upright stanchions spaced apart from one another. In other embodiments, the generally upright frame can include a single, central upright stanchion. Optionally, the hand truck for moving a ceramic cooker can include one or more handles for grasping and controlling the hand truck while moving it from place to place.

In some embodiments, the yoke can include an adjustable element for allowing the yoke to completely and snugly encircle the ceramic cooker. In other embodiments, the adjustable element for allowing the yoke to completely and snugly encircle the ceramic cooker can include a flexible strap. In some embodiments, the yoke can include an adjustable element for allowing the yoke to engage a majority of the ceramic cooker. In some embodiments, the yoke can include a pivotal element for allowing the yoke to closely engage a majority of the ceramic cooker.

Optionally, the yoke can include a resilient element for contacting and engaging the ceramic cooker to avoid damage to the ceramic cooker. Optionally, the hand truck for moving a ceramic cooker can include a fall arrestor for preventing damage to the ceramic cooker in the event of a failure or error in use of the lifting mechanism.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

### BRIEF DESCRIPTION OF THE DRAWING FIGURES

FIG. 1 is a schematic, sectional view of a hand truck according to an example embodiment of the present invention.

FIG. 2 is a top schematic view of a yoke portion of the hand truck of FIG. 1, showing various sizes of interchangeable yokes to accommodate different sizes of ceramic cookers.

FIG. 3 is a rear schematic view of the hand truck of FIG. 1, with some elements omitted for clarity of illustration.

FIG. 4A is a top schematic view of a yoke portion of the hand truck of FIG. 1, in a first optional form.

FIG. 4B is a top schematic view of a yoke portion of the hand truck of FIG. 1, in a second optional form.

FIG. 5 is a schematic, rear view of a hand truck according to another example embodiment of the present invention.

### DETAILED DESCRIPTION

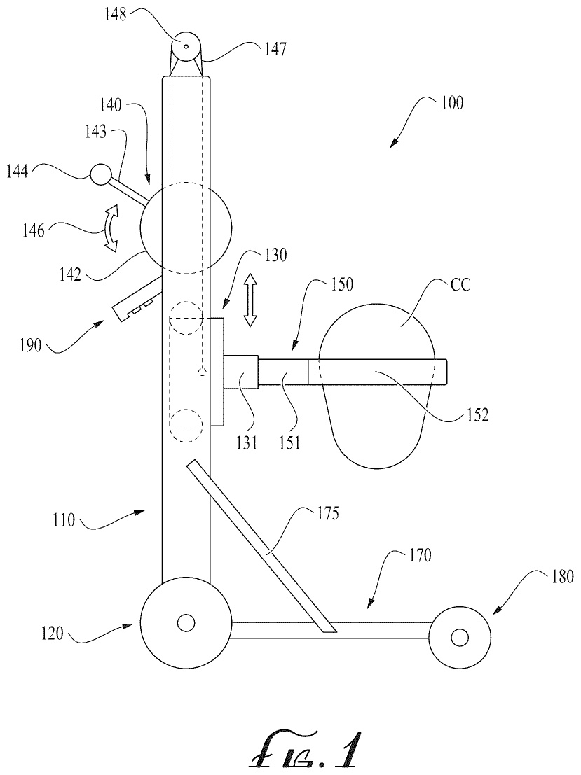

FIG. 1 is a schematic, sectional view of a hand truck according to a first example embodiment of the present invention. The hand truck 100 includes a generally upright frame 110, a first pair of wheels 120 attached to the frame 110 for movably supporting the frame 110 upon a surface, a movable carriage 130 mounted to the frame 110 for up and down movement, a lifting mechanism 140 mounted to the frame 110 for raising and lowering the movable carriage 130, and a yoke 150 mounted to the movable carriage 130 and adapted to be positioned at least partially around the ceramic cooker and to support the ceramic cooker. The hand truck 100 can be moved into position to place the yoke 150 at least partially around the ceramic cooker CC and the lifting mechanism 140 operated to raise the ceramic cooker and to support the ceramic cooker while the hand truck 100 may be wheeled from one place to another, whereupon the lifting mechanism 140 can be operated to lower the ceramic cooker CC into position at a new location.

In some embodiments, the lifting mechanism 140 can comprise a hand-powered winch 142 including a crank arm 143 and a handle 144. The winch 142 may be turned in either direction as indicated at arrows 146 to raise or lower the movable carriage 130. The lifting mechanism 140 includes a steel cable 147 and an upper pulley 148 attached to the top of the upright frame 110. Optionally, the hand-powered winch 142 can be replaced with an electric winch.

In some embodiments, the movable carriage 130 can include a receiver 131 for receiving the yoke 150. In this regard, the receiver 131 is much like a receiver hitch on the back of an automobile for receiving a trailer or other accessory. Advantageously, the use of a receiver 131 facilitates the use of multiple sizes of yokes 150. The yoke 150 includes a tongue 151 to be securely received in the receiver 131 and a cooker grasping portion 152 for engaging and supporting the ceramic cooker.

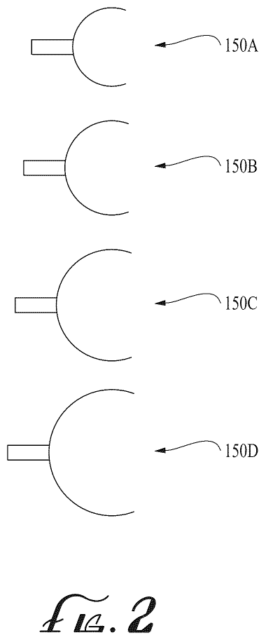

Note that not all ceramic cookers are of the same size. Indeed, ceramic cookers come in a variety of sizes. By having a receiver 131 on the movable carriage 130, the user can select an appropriate size yoke to fit the particular ceramic cooker CC being moved. The user can then insert the appropriate yoke into the receiver 131. Typically, it would be locked in place with a pin or bolt. In this regard, FIG. 2 shows four different sizes of yoke, 150A, 150B, 150C, 150D, to accommodate different sizes of ceramic cookers.

The upright frame can be attached to a lower chassis 170. The lower chassis 170 extends generally transverse to the upright frame 110 and includes a pair of wheels 180 at the distal end of the chassis 170. One or more braces 175 extends between the upright frame 110 and the lower chassis 170.

One or more handles 190 can be provided on the upright frame 110 to allow user of the hand truck 100 to grasp the handle(s) and control the positioning and movement of the hand truck 100.

In some embodiments, the generally upright frame 110 may include two upright stanchions spaced apart from one another. In some embodiments, the generally upright frame 110 may include a single, central upright stanchion. In some embodiments, the yoke 150 may include an adjustable element for allowing the yoke 150 to engage a majority of the ceramic cooker. In some embodiments, the yoke 150 may include a pivotal element for allowing the yoke 150 to closely engage a majority of the ceramic cooker. In some embodiments, the yoke 150 may include a resilient element for contacting and engaging the ceramic cooker to avoid damage to the ceramic cooker.

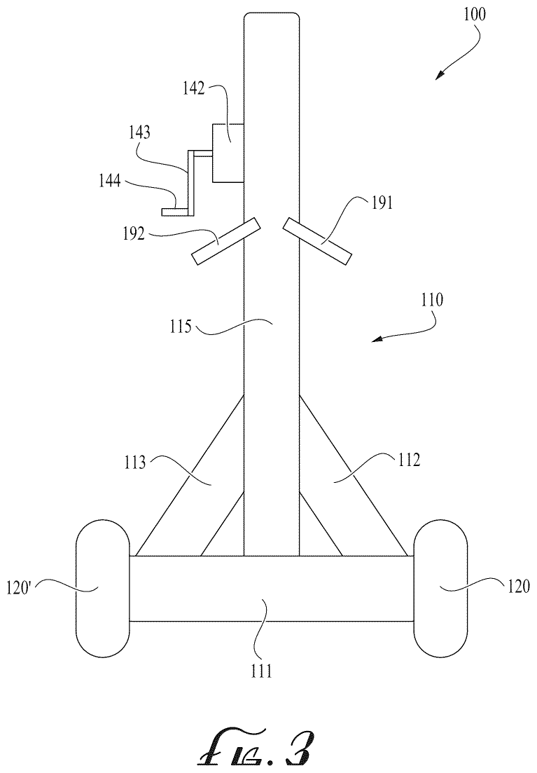

FIG. 3 is a schematic rear view of the hand truck of FIG. 1, with some elements omitted for clarity of illustration, including the yoke. As shown in this figure, the upright frame 110 in this example embodiment takes the form of a monopole frame. Note that the upright frame 110 includes a cross-piece 111, two side braces 112 and 113 attached to an extending upwardly at an angle from the cross-piece 111. The side braces 112 and 113 engage and support the upright post 115. The post 115 is also attached to the cross-piece 111. These elements form a rigid, strong structure. This example embodiment of the hand truck 100 includes handles 191 and 1 92. Also shown in this figure is the hand powered winch 142 including a crank arm 143 and a handle 144. A pair of wheels 120 and 120′ support the hand truck 100 movably upon a surface. Unshown in this figure is the lower chassis and the second pair of wheels.

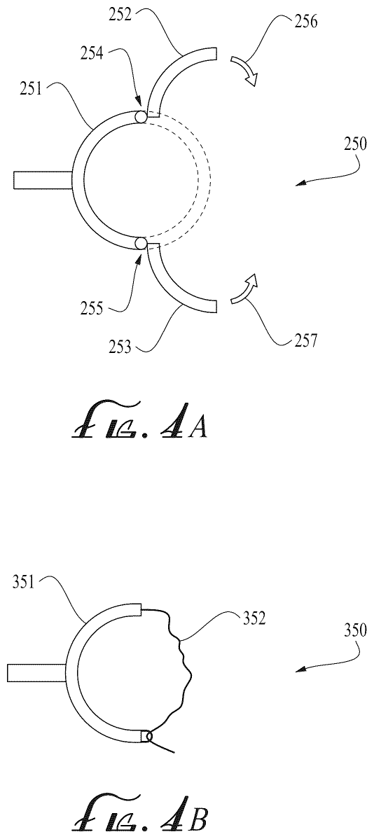

FIG. 4A is a top schematic view of a yoke portion of the hand truck 100 of FIG. 1, in a first optional form. As shown in FIG. 4A, a yoke 250 can have a generally C-shaped first portion 251 attached to and supporting a pair of arcuate sections 252 and 253. Elements 252 and 253 are pivotally connected to the C-shaped section 251 at hinges 254 and 255. With this construction, the yoke 250 can be moved to partially encircle a ceramic cooker with the C-shaped section 251 engaging the ceramic cooker. The wings or arcuate elements 252 and 253 would then be swung into position in the direction of direction arrows 256 and 257 until the yoke assumes the full circular configuration as depicted by the dashed lines. The arcuate elements 252 and 253 would then be secured in place with an unshown latch or other securement means.

FIG. 4B is a top schematic view of a yoke portion of the hand truck 100 of FIG. 1, in a second optional form. As shown in FIG. 4B, a yoke 350 can have a generally C-shaped first portion 351 attached to and supporting a flexible strap 352. With this construction, the yoke 350 can be moved to partially encircle a ceramic cooker with the C-shaped section 351 engaging the ceramic cooker. The strap element 352 would then be looped around the remainder of the ceramic cooker until the yoke assumes the full circular configuration. The strap 252 would then be secured in place with an unshown latch or other securement means.

Thus, according to some embodiments of the present disclosure, the yoke may include an adjustable element for allowing the yoke to completely and snugly encircle the ceramic cooker.

In some embodiments, the hand truck may include a fall arrestor for preventing damage to the ceramic cooker in the event of a failure or error in use of the lifting mechanism 140. Such a fall arrestor can take many forms. For example, strong pins can be placed in holes in the upright frame once the ceramic cooker is lifted with the winch, with the position of the pins being chosen and adapted to arrest the fall of the movable carriage in the event of a failure of the winch or an error by the user in using the winch.

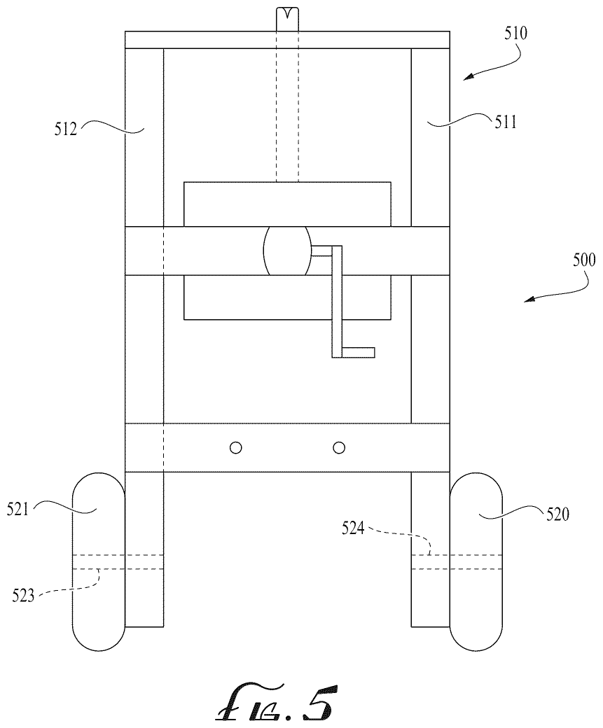

As mentioned previously, in some embodiments, the generally upright frame may include two upright stanchions spaced apart from one another. FIG. 5 is a schematic, rear view of a hand truck according to another example embodiment of the present invention and showing a dual-stanchion upright frame. The hand truck 500 includes A generally upright frame 510 including a first upright stanchion 511 and a second upright stanchion 512 space to distance from the first upright stanchion 511. The upright frame 510 is movably supported upon a surface by wheels 520 and 521, which are rotatably mounted to the upright frame 510 by axles 523 and 524.

The present invention enables a person to lift and transport a ceramic cooker. Such cookers are large and heavy and normally cannot be lifted by a single person. The present invention is useful in lifting and/or transporting such ceramic grills, enabling a person to lift and place the grill on a table, stand, or the like to be used, displayed, or stored. This invention also allows the grill to be mobile, to be easily moved to a campsite, a deck, cooking events, and other locations.

The present device advantageously may be constructed of aluminum and/or steel—however other materials may be employed and be within this invention. Preferably, the device has a height of about 65″ and a width of about 24″. The device may be constructed of two aluminum channels 65″ long, with two 2″×3″ angles of aluminum welded the entire length forming a slide gateway for a 14″×23″ steel or aluminum carriage plate on roll bearings. The carriage thus being allowed to travel the entire length of the frame.

A 2″×2″ receiver hitch {female} can be welded to the carriage plate. A hand lever winch similar to a boat-style cable winch can move the carriage plate up and down. Optionally the winch can be a nylon or other fabric strap. The female receiver hitch receives a male receiver hitch that is attached by welding to the optional ring clamps that encircle the ceramic grill for lifting and lowering by the hand winch. The hand winch is advantageously mounted on the back of the lift device welded in the center of the device about one-half way between the top and the bottom.

Preferably the base of the lift device is mounted on an axle which has two tires attached on opposite sides thereof. Advantageously the tires are rubber and preferably are pneumatic tires of about 4.8″×4″ size. Such large rubber tires aid in allowing the lift device to be tilted back and rolled when a ceramic grill is loaded thereon, easily mobilizing the ceramic grill. A 2″×2″ square steel or aluminum tube extends to the front side of the lift device at its base that is adjustable from about 36″ to about 42″, is adjustable and removable, and has two 3″ bearing type roller wheels mounted to a T-bar at the end. The bar supports the weight of the ceramic grill when it is lifted or being transported. The 2″×2″ support tube is attached to the lift base and reinforced at the attachment points by two steel angles which provide strength and enhance the ability to support the weight of the ceramic grill being lifted and/or transported.

In order to more easily tilt back the lift device two aluminum handles are attached to the back of the lift so that the lift with a ceramic grill attached can be tilted or pulled back onto the tires and transported to another location. The aluminum handles advantageously are tubular shaped and are welded vertical to the back of the 4″ frame channel of the lift.

The drawings and photos depict the ring clamps or bands that attach around a ceramic grill and connect to the lift in order to lift and/or transport a grill. Advantageously the ring clamps are constructed of 2″ rolled steel with a hinged gate allowing the ring to open and dose around the circumference of a ceramic grill. A male type 2″ steel receiver hitch is at the rear of the ring damp which fits into the female receiver hitch mounted on the grill lift. This hitch on the ring clamp is further supported on each side by metal braces which attach to points along the circumference of the ring. A close and latch type handle which applies tension to the ring clamp is present where the bolt is located on the ring clamp. Such a close and latch arrangement is similar to that used to secure a propane tank onto a forklift for rapid installation and removal. Preferably, the ring damps have an inner protective lining or coating to prevent damage to the ceramic grill during lifting and transport. Advantageously the lining or coating in a gasket material, a polymer, a nylon, or the like material.

Alternatively, the ring clamps can be constructed of aluminum, thereby making the band and the weight of the lift lighter. Also, the ring band can be made entirely of a material such as a polymer or nylon strapping-eliminating metal from the band material. This allows for one band to fit different size ceramic grills whereas when using metal bands different bands must be used for differing circumference grills.

When using such strapping material bands, the male receiver will have two attaching points on the hitch, the material will be attached at both of these points to completely encircle the circumference of the grill, with a jack strap handle to apply and release tension of the strap for lift and/or transport. Such a material band eliminates the need for metal band ring clamps. As discussed above, a locking connector can be used similar to a locking bracket on a forklift to secure propane tanks instead of using a bolt to connect and tighten the metal ring.

Ceramic grills come in various sizes and weights. The smaller grills may be less than 12″ in diameter and weigh less than 40 lbs., whereas larger ceramic grills can have a diameter exceeding 20″ and weigh in excess of 200 lbs. Because of the shape, even the smallest ceramic grills are difficult for a person to lift and move to a table or outdoor cooking venue.

Advantageous optional materials and arrangements to the above described lift are: the attachment plates can be aluminum, the winch cable can be a fabric material, a coated fabric material, a polymer, a nylon, or the like, the ring clamps can be made of aluminum, fabric, coated fabric, polymer, nylon, or the like. In addition, the winch cable can connect directly to the attachment plate rather than to a chain or cable.

While the invention has been shown and described in exemplary forms, it will be apparent to those skilled in the art that many modifications, additions, and deletions can be made therein without departing from the spirit and scope of the invention as defined by the following claims.

What is claimed is:

1. A hand truck for moving a ceramic cooker, comprising:
a generally upright frame;
a first pair of wheels attached to the frame for movably supporting the frame upon a surface;
a movable carriage mounted to the frame for up and down movement;
a lifting mechanism mounted to the frame for raising and lowering the movable carriage;
a yoke mounted to the movable carriage and adapted to be positioned at least partially around the ceramic cooker and to support the ceramic cooker; whereby the hand truck can be moved into position to place the yoke at least partially around the ceramic cooker and the lifting mechanism operated to raise the ceramic cooker and to support the ceramic cooker while the hand truck is wheeled from one place to another, whereupon the lifting mechanism can be operated to lower the ceramic cooker into position at a new location.

2. A hand truck for moving a ceramic cooker as claimed in claim 1 further comprising a second pair of wheels positioned to create, in conjunction with the first pair of wheels, a four wheel lower frame positioned to stably support the hand truck while loaded with a ceramic cooker.

3. A hand truck for moving a ceramic cooker as claimed in claim 1 wherein the lifting mechanism comprises a winch.

4. A hand truck for moving a ceramic cooker as claimed in claim 3 wherein the winch is hand-powered.

5. A hand truck for moving a ceramic cooker as claimed in claim 3 wherein the winch comprises an electric winch.

6. A hand truck for moving a ceramic cooker as claimed in claim 1 wherein the movable carriage comprises a receiver and the yoke is removably mounted in the receiver.

7. A hand truck for moving a ceramic cooker as claimed in claim 6 further comprising a plurality of yokes of various sizes to accommodate and support ceramic cookers of various sizes.

8. A hand truck for moving a ceramic cooker as claimed in claim 1 wherein the generally upright frame comprises two upright stanchions spaced apart from one another.

9. A hand truck for moving a ceramic cooker as claimed in claim 1 wherein the generally upright frame comprises a single, central upright stanchion.

10. A hand truck for moving a ceramic cooker as claimed in claim 1 further comprising one or more handles for grasping and controlling the hand truck while moving it from place to place.

11. A hand truck for moving a ceramic cooker as claimed in claim 1 wherein the yoke comprises an adjustable element for allowing the yoke to completely and snugly encircle the ceramic cooker.

12. A hand truck for moving a ceramic cooker as claimed in claim 11 wherein the adjustable element for allowing the yoke to completely and snugly encircle the ceramic cooker comprises a flexible strap.

13. A hand truck for moving a ceramic cooker as claimed in claim 1 wherein the yoke comprises an adjustable element for allowing the yoke to engage a majority of the ceramic cooker.

14. A hand truck for moving a ceramic cooker as claimed in claim 1 wherein the yoke comprises a pivotal element for allowing the yoke to closely engage a majority of the ceramic cooker.

15. A hand truck for moving a ceramic cooker as claimed in claim 1 wherein the yoke comprises a resilient element for contacting and engaging the ceramic cooker to avoid damage to the ceramic cooker.

16. A hand truck for moving a ceramic cooker as claimed in claim 1 further comprising a fall arrestor for preventing damage to the ceramic cooker in the event of a failure or error in use of the lifting mechanism.
